(19) United States
(12) Patent Application Publication
(10) Pub. No.: US 2002/0042222 A1
(43) Pub. Date: Apr. 11, 2002

(54) Method for manufacturing a cable connector assembly and a cable connector assembly thus formed

(76) Inventor: Jian Tao Lin, Kunsan (CN)

Correspondence Address: Wei Te (Joseph) Chung, Foxconn International, Inc., 1650 Memorex Drive, Santa Clara, CA, 95050, US

(21) Appl. No.: 09/882,670

(22) Filed: Jun. 15, 2001

(30) Foreign Application Priority Data
Oct. 6, 2000 (TW) 89120833

(51) Int. Cl. H01R 13/58

(52) U.S. Cl. 439/470

(57) ABSTRACT

A method for forming a fixing plate of a cable connector assembly comprises the steps of: providing a cable; providing a mold assembly comprising a bottom mold and a top mold, the bottom mold defining a bottom groove and a recess therein, the depth of the recess having a larger size than the diameter of the cable, the top mold defining a top groove aligned with the bottom groove and a pressing protrusion corresponding to the recess of the bottom mold; positioning the cable in the recess of the bottom mold; closing the top and bottom molds of the mold assembly, the cable being snugly retained between a bottom of the recess of the bottom mold and the pressing protrusion of the top mold; and injecting molten plastic into the top and bottom grooves of the mold assembly to form the fixing plate.

### BACKGROUND OF THE INVENTION

1. Field of the Invention

The present invention relates to a method for manufacturing a cable connector assembly and a cable connector assembly thus formed, and particularly to a method for manufacturing a cable connector assembly adapted for electrically connecting a multimedia device with a computer.

2. Description of Related Art

A cable connector assembly comprises a cable 7 (FIG. 7), a connector (not shown) assembled to one end of the cable 7, and a fixing plate 8 adjacent to another end of the cable 7 for resisting a pulling force exerted on the cable 7. The fixing plate 8 is formed by insert molding. The cable 7 has an outer plastic coating and a plurality of wires received in the outer plastic coating. FIG. 6 shows a partial, cross-sectional view of a conventional mold assembly. The mold assembly comprises a bottom mold 5 and a top mold 6. The bottom mold 5 defines a bottom semi-cylindrical recess 52 and a bottom groove (not shown). The top mold 6 defines a top semi-cylindrical recess 62 corresponding to the bottom semi-cylindrical recess 52 and a top groove (not shown) corresponding to the bottom groove. The radius of each recess is equal to that of the cable. When the cable 7 is positioned in the bottom recess 52 of the bottom mold 5, only a half surface of the cable 7 is received in the bottom recess 52 of the bottom mold 5. Then, the bottom mold 5 and the top mold 6 are closed together and molten plastic is injected into the top and bottom grooves of the mold assembly to form the fixing plate 8. The fixing plate 8 has a mold-dividing line 9, which is formed during the procedure of injection molding, comprising a semi-circular arc at a position adjacent to the cable 7.

However, due to the flexible nature and size of the cable 7 and the shape of the bottom recess 52, when the cable 7 is positioned in the bottom recess 52, the cable 7 is easily displaced to be partially out of the bottom recess 52. On the other hand, when it is required that the cable 7 be formed at a predetermined angle with respect to the fixing plate 8, the bottom recess 52 of the bottom mold 5 should also be formed at a corresponding predetermined angle with respect to the bottom groove. When the cable 7 is positioned in this angled bottom recess 52, the cable 7 will tend to restore to its original straight configuration, thus apt to deform to be partially out of the bottom recess 52. Furthermore, the thickness of the outer plastic coating of the cable 7 is only about 0.1 millimeter such that, as a result of the cable 7 being partially out of the bottom recess 52, the cable 7 is easily damaged by the top mold 6 when the bottom mold 5 and the top mold 6 are coupled together.

Hence, an improved method for manufacturing a cable connector assembly is desired to overcome the disadvantages of the related art.

### SUMMARY OF THE INVENTION

An object of the present invention is to provide a method for forming a fixing plate for a cable connector assembly wherein a cable can be easily and stably positioned in a bottom mold of a mold assembly during manufacturing.

To achieve the above-mentioned object, a method for forming a fixing plate of a cable connector assembly comprises the steps of: providing at least one cable; providing a mold assembly comprising a bottom mold and a top mold, the bottom mold defining a bottom groove and at least one recess therein, the depth of the at least one recess having a larger size than the diameter of the at least one cable, the top mold defining a top groove aligned with the bottom groove and at least one pressing protrusion corresponding to the at least one recess of the bottom mold; positioning the at least one cable in the at least one recess of the bottom mold below an upper surface thereof; closing the top and bottom molds of the mold assembly, the at least one cable being snugly retained between a bottom of the at least one recess of the bottom mold and the at least one pressing protrusion of the top mold, the top and bottom grooves of the respective top and bottom molds communicating with each other to form a unitary groove; and injecting molten plastic into the top and bottom grooves of the mold assembly to form the fixing plate.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a cable connector assembly in accordance with the present invention;

FIG. 2 is a partial, top plan view of a bottom mold of the present invention;

FIG. 3 is a partial, bottom plan view of a top mold of the present invention;

FIG. 4 is a partial, cross-sectional view of the top and bottom molds before coupling;

FIG. 5 is a partial, cross-sectional view of the top and bottom molds coupled together.

FIG. 6 is a partial, cross-sectional view of a conventional top and bottom molds before coupling; and

FIG. 7 is a perspective view of a conventional fixing plate molded by top and bottom molds shown in FIG. 6.

### DETAILED DESCRIPTION OF THE INVENTION

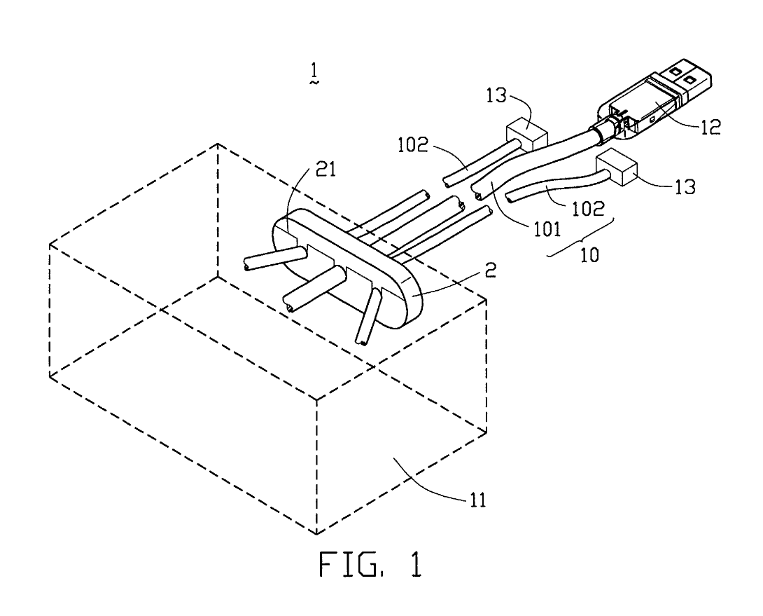

Referring to FIG. 1, a cable connector assembly 1 manufactured by a method in accordance with the present invention comprises a plurality of cables 10, a USB connector 12, a pair of sound boxes 13 shown in solid lines, and a fixing plate 2 through which the cables 10 extend. The cables 10 include a middle cable 101 perpendicular to the fixing plate 2 and a pair of sound cables 102 having a respective section formed at a predetermined angle with respect to the fixing plate 2, wherein one end of the middle cable 101 is assembled with the USB connector 12 and the other end is connected with an electrical device 11 shown in dashed lines, for example a multimedia device. One end of each sound cable 102 is assembled with a corresponding sound box 13 and the other end is also connected with the electrical device 11.

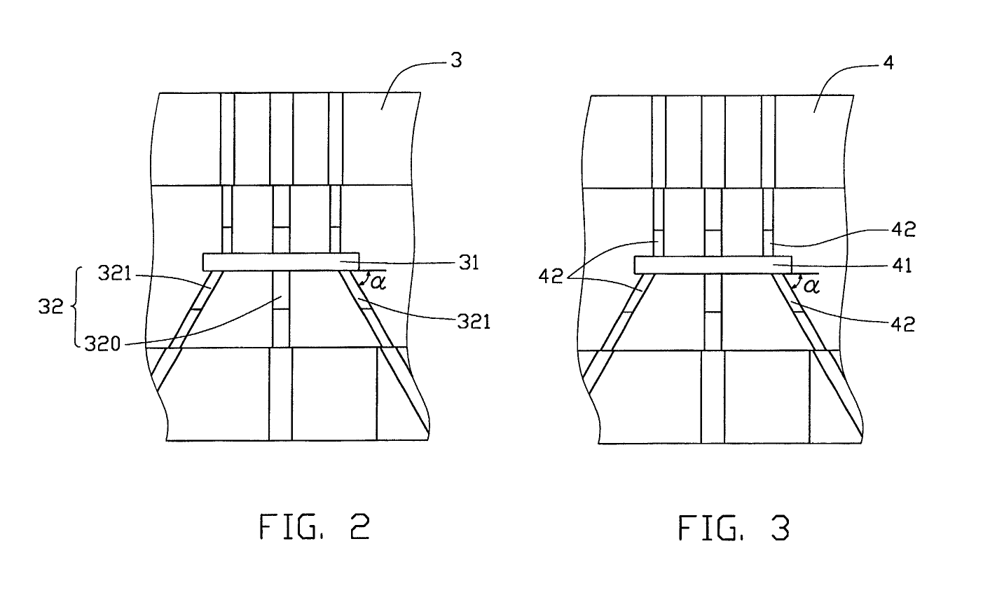

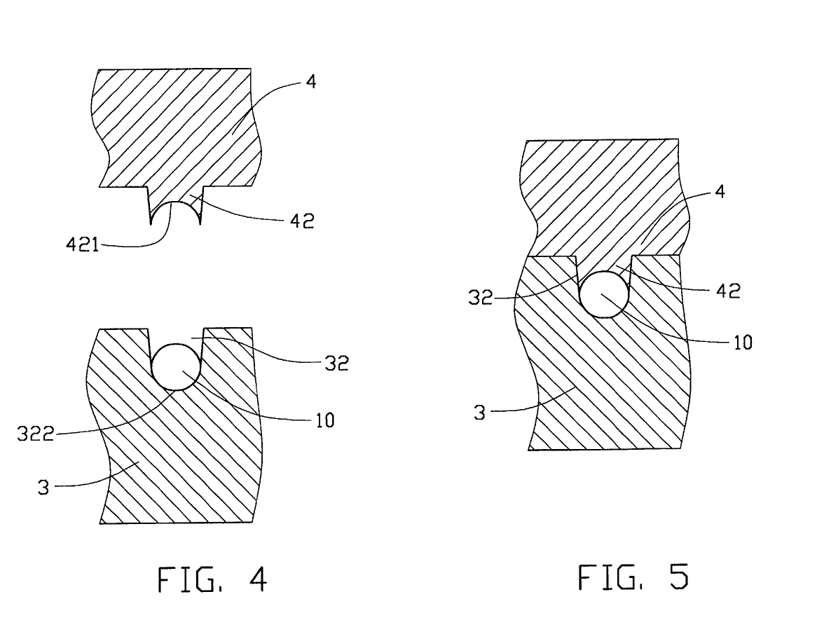

The fixing plate 2 is formed by injection molding. Also, referring to FIGS. 2-4, a mold assembly for molding the fixing plate 2 comprises a bottom mold 3 and a top mold 4. The bottom mold 3 defines a bottom groove 31 and a plurality of recesses 32 for respectively receiving and retaining the cables 10. The depth of each recess 32 is larger than the diameter of each cable 10. The recesses 32 include a middle recess 320 extending in a direction perpendicular to the bottom groove 31 for receiving the middle cable 101 and two side recesses 321 each having a section extending away from the middle recess 320 and being formed at a predetermined angle (α) with respect to the bottom groove 31 for receiving a corresponding sound cable 102. In the preferred embodiment of the present invention, each side recess 321 is formed at an angle of sixty degrees with respect to the bottom groove 31.

The top mold 4 defines a top groove 41 corresponding to the bottom groove 31 and a plurality of pressing protrusions 42 corresponding to the recesses 32 of the bottom mold 3. Each pressing protrusion 42 projects from the top mold 4 and has a curved surface 421 (FIG. 4) at an end thereof for contacting with a corresponding cable 10.

During the process of molding the fixing plate 2, firstly, each cable 10 is received and retained in a corresponding recess 32 of the bottom mold 3 thereby ensuring a reliable contact between the cable 10 and a bottom 322 of the corresponding recess 32, wherein the middle cable 101 is received in the middle recess 320 and each sound cable 102 is received in a corresponding side recess 321. Because the depth of each recess 32 has a larger size than the diameter of each cable 10, the cable 10 can be easily received and retained in the recess 32, and the sound cable 102, which is totally received in the recess 321, will not produce an undesired deformation or displacement.

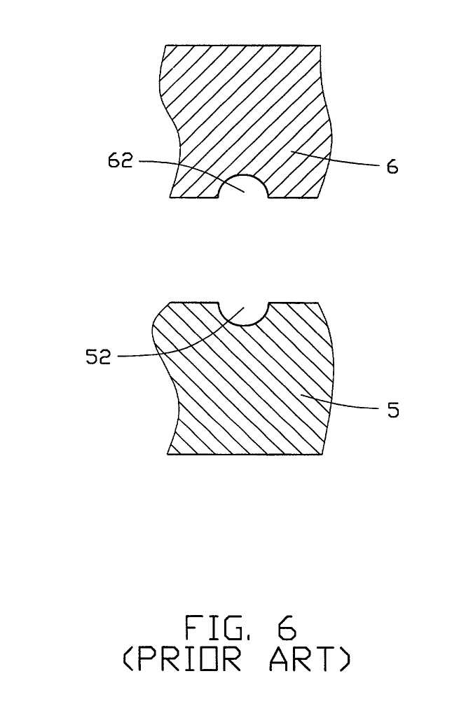

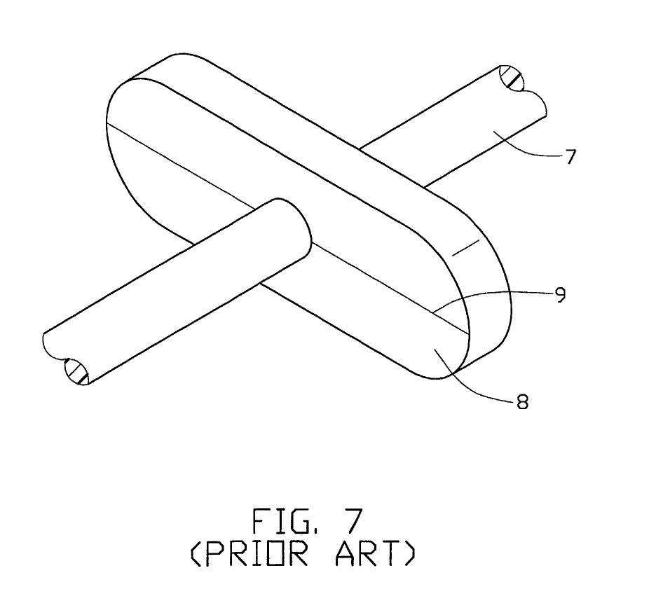

Referring to FIG. 5, when the bottom mold 3 and the top mold 4 are closed together, each cable 10 is snugly retained between the bottom 322 of the recess 32 of the bottom mold 3 and the curved surface 421 of the pressing protrusion 42 of the top mold 4. The bottom groove 31 and the top groove 41 communicate with each other to form a unitary groove. Finally, molten plastic is injected into the bottom groove 31 and the top groove 41 of the mold assembly to form the fixing plate 2. The fixing plate 2 has a mold-dividing line 21, which is formed during the procedure of injection molding, comprising a U-shaped segment at a position adjacent to the corresponding cable 10.

When one end of each cable 10 that is adjacent to the fixing plate 2 is connected with the electrical device 11, the fixing plate 2 abuts against a panel case of the electrical device 11 for functioning as a strain relief to resist a pulling force exerted on the cables 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for forming a fixing plate for a cable connector assembly, comprising the steps of:
providing at least one cable;
providing a mold assembly comprising a bottom mold and a top mold, the bottom mold defining a bottom groove and at least one recess therein, the depth of the at least one recess having a larger size than the diameter of the at least one cable, the top mold defining a top groove aligned with the bottom groove and at least one pressing protrusion corresponding to the at least one recess of the bottom mold;
positioning the at least one cable in the at least one recess of the bottom mold below an upper surface thereof;
closing the top and bottom molds of the mold assembly, the at least one cable being snugly retained between a bottom of the at least one recess of the bottom mold and the at least one pressing protrusion of the top mold, the top and bottom grooves of the respective top and bottom molds communicating with each other to form a unitary groove; and
injecting molten plastic into the top and bottom grooves of the mold assembly to form the fixing plate.

2. The method for forming a fixing plate as claimed in claim 1, wherein the step of providing the mold assembly comprises forming a middle recess and two side recesses on the bottom mold, and forming three pressing protrusions on the top mold corresponding to the recesses on the bottom mold, the middle recess being perpendicular to the bottom groove of the bottom mold, each side recess being formed at a predetermined angle with respect to the bottom groove.

3. The method for forming a fixing plate as claimed in claim 2, wherein the step of providing the mold assembly comprises forming each side recess at an angle of sixty degrees with respect to the bottom groove.

4. A cable connector assembly comprising:
at least one cable;
at least one connector assembled to the at least one cable; and
a fixing plate insert-molded about the at least one cable and having a mold-dividing line comprising a U-shaped segment at a position adjacent to the at least one cable.

5. The cable connector assembly as claimed in claim 4, wherein the at least one cable comprises a middle cable and a pair of sound cables, and the at least one connector comprises an electrical connector assembled to the middle cable and a pair of sound boxes respectively assembled to the sound cables.

6. A molding device and a cable assembly formed therefrom, comprising:
a cable and the associated fixing plate;
a first mold defining a first surface with a recess recessed below said first surface; and
a second mold defining a second surface with a pressing protrusion protruding above said second surface, said pressing protrusion being dimensioned and configured to be able to be compliantly received within the recess; wherein
when forming said fixing plate, said protrusion is inserted into the recess and occupies a portion of said recess while leaving a space which defines a specific shape specifically matching a cross-section of the cable for efficiently holding the cable in position in the recess.

7. The molding device as claimed in claim 6, wherein when assembled, the first surface and the second surface abut against each other.

8. The molding device as claimed in claim 6, wherein said recess defines an arc-like bottom and said protrusion defines an opposite arc-like top, and said bottom and said top together form a contour of said cross-section of the cable.

9. The molding device as claimed in claim 6, wherein said protrusion only occupies an upper portion of said recess, and the space is located around a bottom portion of the recess.

10. The cable assembly as claimed in claim 6. wherein said fixing plate has a mold-dividing line formed thereon after molding, said mold-dividing line generally complying with said second surface and said protrusion along a cross-sectional plane of said second mold.

11. The cable assembly as claimed in claim 10, wherein said mold-dividing line also complies with the said first surface and said recess along another cross-sectional plane of the first mold which is coplanar with said cross-sectional plane of the second mold.

12. A cable assembly comprising:
a round cable; and
a fixing plate attached to the cable, by insert-molding with two molds, with a mold-dividing line thereon; wherein
said mold-dividing line includes horizontal sections which are formed by two abutment surfaces of said two molds, and vertical sections which are formed by a recess of one mold and a protrusion of the other mold which is embedded within said recess.

13. The cable assembly as claimed in claim 12, wherein said vertical sections are with little obliqueness for more easily disassembling the two molds.
